(19) United States
(12) Patent Application Publication
(10) Pub. No.: US 2021/0039164 A1
(43) Pub. Date: Feb. 11, 2021

(54) Laser Assisted, Selective Chemical Functionalization of Laser Beam Powder Bed Fusion Fabricated Metals and Alloys to Produce Complex Structure Metal Matrix Composites

(71) Applicant: Board of Regents, The University of Texas System, Austin, TX (US)

(72) Inventors: Philip A. Morton, El Paso, TX (US); Lawrence E. Murr, El Paso, TX (US); Ryan Wicker, El Paso, TX (US); Hunter Taylor, El Paso, TX (US); Cesar Terrazas, El Paso, TX (US)

(21) Appl. No.: 16/988,943

(22) Filed: Aug. 10, 2020

Related U.S. Application Data
(60) Provisional application No. 62/884,912, filed on Aug. 9, 2019.

(51) Int. Cl. B22F 3/105

(52) U.S. Cl. CPC B22F 3/1055; B33Y 10/00

(57) ABSTRACT

A method of additive manufacturing is provided. The method comprises first forming a part injecting a first gas into a build chamber and depositing a first layer of metal-containing powder over a build platform. The first layer of powder is melted a laser and then cooled. The above steps can be optionally repeated to build additional layers. A coating is formed on the surface of the part by injecting a second, different gas into the chamber over the surface of the part. A portion of the surface is selectively heated with a second laser device, thereby chemically altering the heated portion to form the coating. After forming the coating, an additional aliquot of the first gas is injected into the chamber while venting the second gas from the chamber.

### CROSS-REFERENCE TO RELATED APPLICATION(S)

This application claims the benefit of priority to U.S. Provisional Patent Application No. 62/884,912, filed Aug. 9, 2019, the entire contents of which are incorporated herein by reference.

### BACKGROUND INFORMATION

### 1. Field

The present disclosure relates to additive manufacturing, and more specifically, to an improved method of power bed fusion.

### 2. Background

Surface engineering involving carbonizing and nitriding of metals and alloys to improve surface wear and corrosion resistance, as well as surface hardness, has been utilized for more than a half-century in applications ranging from aerospace and automotive engine and component design, cutting tool and blade optimization, and a variety of orthopedic implant improvements. Titanium nitride (TiN) coatings, in particular, have been especially useful since hardness values can range from 800 to 3000 Vickers hardness numbers (VHN) (8 to 30 GPa); with elastic (Young's) moduli ranging from ˜200 GPa to 500 GPa, and a melting point of 2950° C. TiN coatings can be developed using physical and chemical vapor deposition (PVD and CVD) techniques as well as electron and laser-beam-assisted PVD and CVD, plasma or plasma-assisted deposition, and laser nitriding involving short-pulse laser irradiation of metals and alloys in nitrogen-containing atmospheres where nitrogen uptake and diffusion can be variously manipulated to produce TiN or TiN-rich surface layers of varying thicknesses on Ti-6Al-4V.

### SUMMARY

An illustrative embodiment provides a method of additive manufacturing. The method comprises first forming a part injecting a first gas into a build chamber and depositing a first layer of metal-containing powder over a build platform. The first layer of powder is melted a laser and then cooled. The above steps can be optionally repeated to build additional layers. A coating is formed on the surface of the part by injecting a second, different gas into the chamber over the surface of the part. A portion of the surface is selectively heated with a second laser device, thereby chemically altering the heated portion to form the coating. After forming the coating, an additional aliquot of the first gas is injected into the chamber while venting the second gas from the chamber.

This summary is provided to introduce a selection of concepts that are further described below in the detailed description. This summary is not intended to identify key or essential features of the claimed subject matter, nor is it intended to be used as an aid in limiting the scope of claimed subject matter.

### BRIEF DESCRIPTION OF THE DRAWINGS

The novel features believed characteristic of the illustrative embodiments are set forth in the appended claims. The illustrative embodiments, however, as well as a preferred mode of use, further objectives and features thereof, will best be understood by reference to the following detailed description of an illustrative embodiment of the present disclosure when read in conjunction with the accompanying drawings, wherein:

FIG. 1 illustrates a schematic of nitriding set up relative to gas flow and rake direction in accordance with an illustrative embodiment;

FIG. 2A depicts an unfiltered secondary electron scanning electron microscope (SEM) image of a nitride layer in accordance with an illustrative embodiment;

FIG. 2B depicts an SEM image with median filtering and histogram equalization applied with Matlab™ in accordance with an illustrative embodiment;

FIG. 2C depicts an SEM image with an image threshold using Ostu's method via ImageJ software in accordance with an illustrative embodiment;

FIG. 2D depicts an SEM image with selection of errors of Otsu's method thresholding for manual filling of dendrites in accordance with an illustrative embodiment;

FIG. 2E depicts an SEM image with final image for analysis with filtered procedure, image threshold, and manual correction in accordance with an illustrative embodiment;

FIG. 3A depicts an SEM image showing relatively dense matrix of dendrites in a Ti64 Matrix in accordance with an illustrative embodiment;

FIG. 3B depicts an SEM image with slightly finer dendrite arm spacing and more matrix present in accordance with an illustrative embodiment;

FIG. 4A depicts a graph of X-ray diffraction results from L-PBF Ti64 processed entirely in argon with image of the Ti64 cube surface subjected to x-ray radiation in accordance with an illustrative embodiment;

FIG. 4B depicts a graph of x-ray diffraction results from surface nitrided Ti64 in L-PBF machine with image of golden cube surface subjected to x-ray radiation in accordance with an illustrative embodiment;

FIG. 5A depicts a graph comparing energy input to secondary arm spacing using the more traditional terms of power over hatch times scan speed giving a fairly linear trend in accordance with an illustrative embodiment;

FIG. 5B depicts a graph comparing energy input to secondary arm spacing modifying accounting for spot size to hatch spacing ratio to account for overlapping in accordance with an illustrative embodiment;

FIG. 6 depicts an SEM image showing the distinct martensitic α′ below the TiN dendrites in accordance with an illustrative embodiment;

FIG. 7A depicts a graph illustrating dendrite arm spacing based on average of 10 measurements from two SEM images at 2000× in accordance with an illustrative embodiment;

FIG. 7B depicts a graph illustrating dendrite volume fraction in Ti64 matrix in accordance with an illustrative embodiment;

FIG. 8A depicts an SEM image of an embedded TiN hardness profile cube built with parameter set 7 with Ti64 re-melt power of 300 w in accordance with an illustrative embodiment;

FIG. 8B depicts an SEM image of an embedded TiN hardness profile cube one built with the same nitriding conditions with re-melt of Ti64 powder at 165 w for two layers before returning to 300 w in accordance with an illustrative embodiment;

FIG. 9 depicts a 2000× magnified SEM image from the middle area of the embedded TiN layer in the same sample area from FIG. 4B with the border of re-melted TiN above the as deposited TiN dendrites in accordance with an illustrative embodiment;

FIG. 10A depicts the linear hardness profile across embedded TiN layer for sample built with no reduced power on infill after the nitriding layer in accordance with an illustrative embodiment;

FIG. 10B depicts the hardness profile of a sample built with reduced power infill for two layers after the TiN layer in accordance with an illustrative embodiment;

FIG. 11 depicts a cross-section perspective view of a gas sprayer in accordance with an illustrative embodiment;

FIG. 12 depicts a perspective view of a gas sprayer in accordance with an illustrative embodiment;

FIG. 13 depicts a gas sprayer in use during fabrication of parts in accordance with an illustrative embodiment;

FIG. 14 depicts a flowchart illustrating a process flow for powder bed fusion manufacturing with nitriding in accordance with an illustrative embodiment;

FIG. 15A depicts a diagram illustrating the process of selective laser melting in accordance with an illustrative embodiment;

FIG. 15B depicts a diagram illustrating the process of selective laser gas nitriding in accordance with an illustrative embodiment; and

FIG. 15C depicts a top view of a completed Ti-6Al-4V/TiN metal matrix composite in accordance with an illustrative embodiment.

### DETAILED DESCRIPTION

Illustrative embodiments provide manufacturing processes for fabricating metal matrix composite materials (e.g., Ti-6Al-4V/TiN) in a laser powder bed fusion (L-PBF) system. Illustrative embodiments include selectively injecting a secondary gas (e.g., nitrogen, ammonia, carbon dioxide, carbon monoxide, methane, or the like) into an inert gas (e.g., argon, or the like) laser power bed fusion (L-PBF) atmosphere, and using the laser to heat and react a component of the secondary gas (e.g., nitrogen, or the like) and a component of a build material (e.g., titanium, or the like) to form a chemically functionalized metal matrix composite material (e.g., titanium nitride (TiN)).

The ability to inject and extract a secondary gas improves scalability for the process. It has been demonstrated that the addition of a nozzle to deliver a secondary gas facilitates processing using a method to inject and extract the secondary gas from, e.g., an argon environment. The illustrative embodiments have applications for Ti and Ti alloys, Fe and Fe alloys (including stainless steels), Ni and Cr alloys, aluminum and aluminum alloys, tungsten and tungsten alloys, or the like.

Processing parameters may be modified (e.g., nitrogen concentrations, nitrogen argon mixtures, iatrogenic pressure, temperatures, etc.) to vary, e.g., surface coating thicknesses and corresponding hardness, embedding of nitride layers having various periodicities, and thicknesses to produce complex composite designs.

An additive manufacturing system includes a number of different components, such as, e.g., a controller, a laser system, a powder supply system, and a build platform. The controller is in communication with the laser system. The controller is also in communication with the powder supply system.

The build platform provides an initial substrate to begin deposition of material to form an additively manufactured part. The build platform also provides support for building up sequential component layers of the manufactured part during additive deposition of material to form the part. The powder supply system supplies material for deposition on, above, or over the build platform. The powder supply system includes a powder.

The powder supply system supplies the powder to the build platform. The laser system is configured to heat the powder deposited on, over, or above the build platform.

The controller is a physical hardware system or device that controls and is in communication with the laser system and the powder supply system. In an illustrative example, the controller controls and communicates with the powder supply system to supply and sequentially deposit a number of layers of powder on, over, or above the build platform during additive manufacture of a three-dimensional part. The controller is also configured to control the laser system to apply heat to each of the number of layers of the powder during respective stages of additive manufacture of a three-dimensional part. For example, the controller communicates with the powder supply system to supply and deposit an initial layer of powder on the build platform. The controller then communicates with the laser system to heat the initial layer of powder to initiate melting and adhesion between and among particles of the powder of the initial layer.

The heated initial layer is then cooled. In some examples, cooling can include an active process of removing thermal energy from the part or a layer of the part. In other examples, cooling can include a passive process of allowing a heated layer to radiatively dissipate heat to the local environment.

The controller thereafter communicates with the powder supply system to supply and deposit another layer of powder on the cooled initial layer. The process is repeated to build up additional melted and adhered layers until fabrication of the three-dimensional part is substantially complete.

The controller can be implemented in software, hardware, firmware or a combination thereof. When software is used, operations performed by the controller can be implemented in program code configured to run on hardware, such as a hardware processor unit. When firmware is used, the operations performed by the controller can be implemented in program code and data stored in persistent memory to run on a processor unit. When hardware is employed, the hardware can include circuits that operate to perform operations in the controller.

In illustrative embodiments, hardware can take a form selected from at least one of a circuit system, an integrated circuit, an application specific integrated circuit (ASIC), a programmable logic device, or other suitable type of hardware configured to perform a number of operations. With a programmable logic device, the device can be configured to perform any number of operations. The device can be reconfigured at a later time or can be permanently configured to perform any number of operations. Programmable logic devices include, for example, a programmable logic array, a programmable array logic, a field programmable logic array, a field programmable gate array (FPGA), or other suitable hardware devices. Additionally, processes can be implemented in organic components integrated with inorganic components, and can be comprised entirely of organic components excluding a human being. For example, processes can be implemented as circuits in organic semiconductors.

The illustrative embodiments provide a method for selectively nitriding Ti-6Al-4V component surfaces during additive manufacturing of such components using a L-PBF system. The method can utilize, e.g., argon (Ar) or nitrogen (N₂) processing environments—an approach not previously developed for metal and alloy additive manufacturing (AM). Laser nitriding of Ti-6Al-4V components during the AM process produces TiN/Ti-6Al-4V micro-dendritic surface layers as thick as 230 μm. In addition, TiN embedded layers can also be fabricated in Ti-6Al-4V AM products. These embedded layers might range in thickness from ˜75 μm to 150 μm. This novel processing technique is a precursor to developing hybrid, periodic layers of hard and soft (brittle/ductile) TiN/Ti6Al-4V composites. Optical and scanning electron microscopy were employed in characterizing these TiN-rich coatings along with XRD analysis. Vickers microindentation hardness measurements were performed comparatively on the uncoated and nitride coated Ti-6Al-4V component surfaces and the embedded TiN layers.

Precursor Ti-6Al-4V metal powder sourced from LPW Technologies Inc. (Imperial, Pa., USA) was utilized for all experiments. Prior to the experiments described herein, the powder had been reused several times in an Arcam A2 (GE Additive, Sweden) electron beam powder bed fusion (EB-PBF) machine. Particle size and shape analyses were conducted on a Retsch Camsizer X2 (Haan, Germany), yielding d₁₀=46 μm, d₅₀=60 μm, and d₉₀=92 μm and sphericity with 88% of particles having a symmetry greater than 0.9. Oxygen content of the powder was quantified using an Eltra ONH-p (Haan, Germany), measured at 0.17% O₂, and thus meeting the 0.2% specified for Grade 5 titanium in ASTM F2924-14.

All experimentation was performed on an AconityONE L-PBF system (Aconity3D, Aachen, Germany). This system is equipped with a 1 kW ytterbium (Yb) fiber Laser (IPG Photonics, Oxford, Mass., USA) with a wavelength of ˜1070 nm. The AconityONE performs focal plane compensation and galvanometer scanning via flying optics (Raylase AxialScan-30, Wessling, Germany). The flying optics replace the commonly used f-theta lens with the principal benefit being that the system can maintain a focused spot over the surface of the powder bed, and although the beam focal distance is controlled to stay focused on the surface, a circular beam at the centerline becomes a more elliptical projection on the surface as the angle of the beam increases at the edges. The flying optics also allow for dynamic changes in spot size on the powder bed that could be used, for example, to selectively create larger melt-pools and possibly faster build speeds. In the case of this study, a positive defocus pushed the focal plane below the powder surface creating a convergent beam at the interaction plane between the laser and the powder/part surface, while a negative defocus resulted in the exact opposite (i.e. an expanding beam at the interaction plane).

Fabrication of sample Ti-6Al-4V cubes was done in a standard configuration under an inert Ar environment, specifically at O₂<500 ppm, chamber pressure of 40 mbar, and an inert gas consumption of 3.5 L/min. Substrate specimens with dimensions of 10×10×6 mm (L×W×H) were built with the following parameters: power 300 W, line speed 1000 mm/s, and hatch space of 0.9 mm. Slicing of the stereolithography (STL) models was performed in NetFabb Ultimate (Autodesk, San Rafael, Calif., USA) at a 50 μm layer thickness. All builds were performed at ambient temperature with no powder bed preheating.

Fabrication was done in two steps. First, the deposition of Ti-6Al-4V was performed onto the build substrate under the Ar environment. Then, once the cube substrate build height reached 6 mm, the build was paused and the AconityONE's chamber was allowed to cool down to ambient conditions and opened to allow flooding by atmospheric air. After this step, the top layer was brushed off manually of any powder to ensure a clean surface for nitriding. In the second fabrication step, the chamber of the AconityONE was left open for ˜one hour and was then closed and purged with N₂ until the oxygen level was below 500 ppm. The oxygen level served as an indicator of a clean (nitrogen rich) atmosphere to proceed with the nitriding process. The chamber pressure was held at 40 mbar during the nitriding.

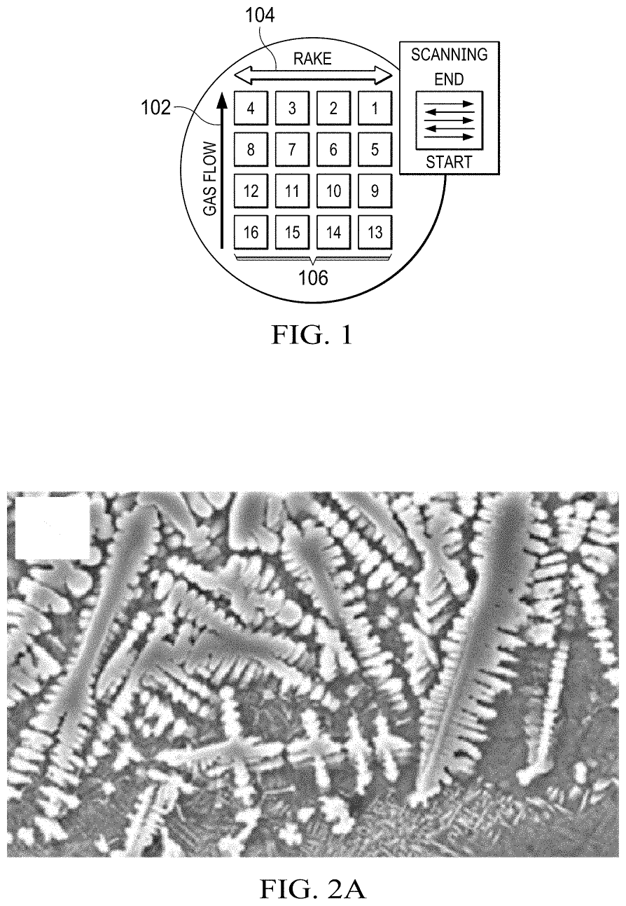

FIG. 1 illustrates a schematic of nitriding set up relative to gas flow 102 and rake direction 104 in accordance with an illustrative embodiment. Laser-assisted nitriding was carried out on 16 cubes 106 with each cube receiving a unique set of laser exposure parameters listed in Table 1 (below). Different defocus laser parameters were employed for each cube 106 with the intention to control melt-pool size and solidification rate. The defocused beam size was calculated utilizing Equation 1 below:

$$ω ( z ) = {ω}_{0} \sqrt{1 + {( \frac{\text{?}}{{M}^{2} \cdot {z}_{R}} )}^{2}} \\ \text{?} \text{indicates text missing or illegible when filed} \qquad ( 1 )$$

where (ω₀) is the beam waist radius, (z_{R}) is the Rayleigh length, and M² was the diffraction coefficient. For the experiments performed, these parameters were quantified by the manufacturer during installation and commissioning for the AconityONE system to be 40 μm, 3.98 mm, and 1.18, respectively. The scan strategy was the same for all cubes with 9.5 mm vector length scanned perpendicular to the gas flow across the print bed. Energy density (Q) values applied to each cube fabricated were computed through the relationship using Equation 2 and the different processing parameter settings as listed in Table 1 (below):

$$Q = \frac{p}{V * h} \qquad ( 2 )$$

where Q is the energy density in J/mm², P is the power in Watts (J/s), V is the laser scanning velocity in mm/s, and h the hatching space in mm. A variation of Equation 2 was also employed in this research to account for the laser beam overlap by introducing the beam diameter σ in units of mm as shown in Equation 3 below:

$${Q}^{′} = \frac{σ * P}{V * h} \qquad ( 3 )$$

where in this equation, Q′ represents the adjusted energy density in J/mm. Both Equations 2 and 3 were employed to calculate the energy density delivered to each cube 106 during nitriding and then later correlated with the TiN dendrite secondary arm spacing in μm.

Samples were removed from the build plate with a horizontal band saw using water-based lubricant and subsequently cleaned of oil. Prior to performing any metallography, all samples were subjected to x-ray diffraction on a Bruker D8 Discovery X-Ray diffractometer (Bruker, Billerica, Mass., USA) equipped with a Cu k_{α} source and a SuperSpeed line detector. The samples were positioned with the nitriding scan vectors perpendicular to the incident beam. The samples were scanned at 1 sec/step, 0.02°/step from 20° to 80° (2θ).

Once removed from the build plate and subjected to x-ray diffraction, samples were sectioned on a Brilliant 220 8″ high-speed-water-cooled saw (ATM, Mammelzen, Germany) to reveal the YZ face perpendicular to the laser nitriding scan vector. A pulsing cut was utilized to reduce sample heating which may negatively impact the fidelity of the microstructure. Eight samples were mounted in epoxy at once by orientating each of their cut faces down. This was done in an OPAL 460 hot mounting machine (ATM, Mammelzen, Germany). A thin layer of carbon laced conductive hot mounting epoxy was applied toward the top of each mounted sample and then backfilled with a black phenolic hot mounting powder. The thin conductive layer facilitated scanning electron microscopy (SEM) imaging.

Mounted samples were ground and polished on a Saphir 530 automated polisher (ATM, Mammelzen, Germany). Standard grinding and polishing techniques were utilized with the final step using a 1 μm polycrystalline diamond in a water-free lubricated suspension on a napped pad. Prior to optical and SEM observation, samples were swab etched for 12 seconds using Krolls reagent (90 ml distilled water, 6 ml nitric acid (HNO₃), and 2 ml hydrofluoric acid (HF)). Optical observations were carried out on an Olympus GX53 inverted microscope (Tokyo, Japan). Scanning electron microscopy was performed on a JEOL IT500LV (Tokyo, Japan).

Hardness testing was performed for specimens in the as-polished state prior to etching. Vickers micro-hardness testing was conducted on a Duramin-A300 (Struers GMBH, Willich, Germany), at a load of 100 gf and a dwell time of ˜10 seconds. Indents were performed on the cross section of the samples; none were attempted on the top nitride surface due to the high roughness. Only samples with nitride thickness greater than 45 μm were subjected to indentations. ASTM E92-17 states indentations to be spaced no less than 2.5× the Vickers diagonal length from another indentation (center to center) or from the sample edge. The indent size within the cross section of the nitride layer was typically around 15 μm, meaning the indents' center should be 37.5 μm from the sample's edge. In the case of this work, five indents were made on each sample with a distance from the top surface of the sample ranging from 25 μm to 35 μm. The indent locations were closer to the samples edge than what ASTM recommends to obtain hardness of the thin TiN surface layer and not the Ti-6Al-4V matrix. Embedded nitride layers were tested using the same methodology with the addition of a continuous diagonal line of indents made across the embedded TiN layer. The indentations were spaced at approximately 40 μm apart based on the approximate diagonal length of 15 μm and the 2.5× diagonal length spacing rule from ASTM E92-17 (and the TiN/Ti-6Al-4V interface was not considered an edge). To increase the number of indents made across the embedded layer, the hardness profile was placed at an angle instead of following parallel to the build direction. The Vickers diagonal length size in the Ti-6Al-4V averages closer to 20 μm, but the spacing was kept constant at 40 μm.

Secondary electron SEM images taken at a constant magnification of 2000× were acquired during the sample characterization to determine dendrite arm spacing and the dendrite volume fraction of the TiN phase. Area fraction of dendrites in the surface nitride layers were estimated across samples utilizing a standard 30 μm×50 μm rectangular area. The top of this area was aligned with the lowest visible point of mounting epoxy.

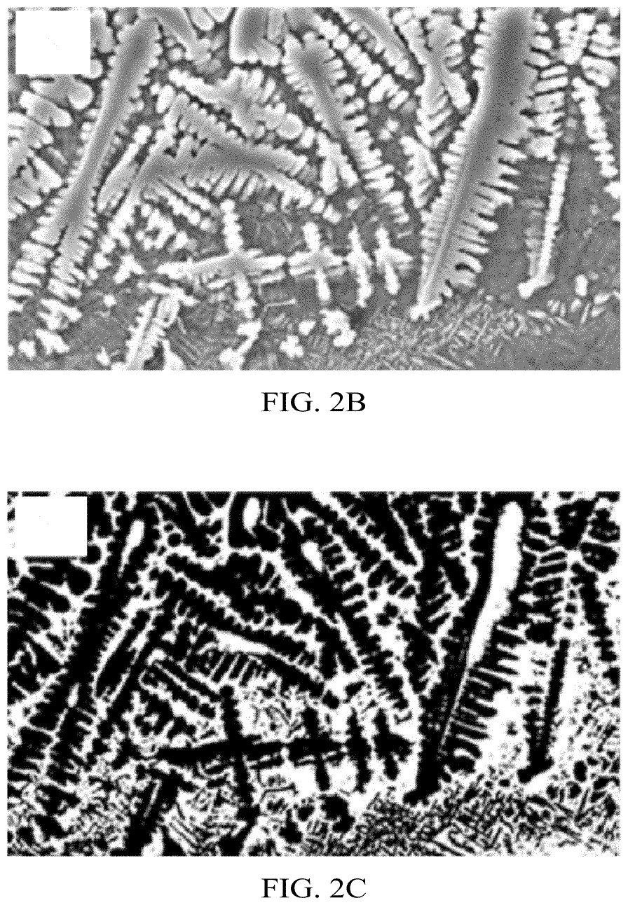

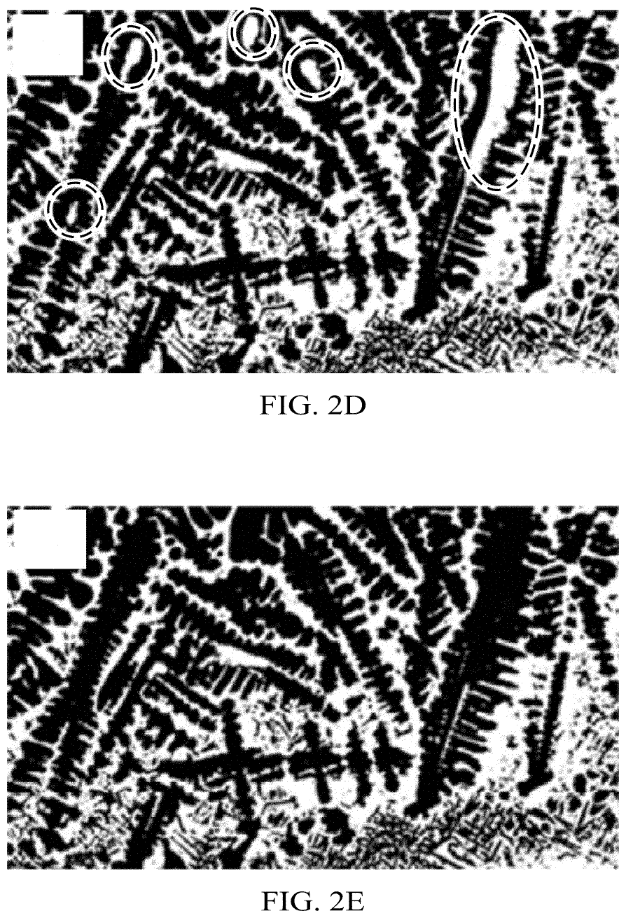

FIGS. 2A-2E show image analysis procedure images of (A) an unfiltered secondary electron SEM image of the nitride layer, (B) an SEM image with median filtering and histogram equalization applied with Matlab™, (C) image thresholding using Ostu's method via ImageJ software, (D) selection of errors of Otsu's method thresholding for manual filling of dendrites, and (E) the final image for analysis with filtered procedure, image threshold, and manual correction in accordance with illustrative embodiments.

The acquired images were subjected to a pre-processing procedure prior to dendrite area percentage calculation, attempting to reduce errors in image analysis. The pre-processing procedure consisted of histogram equalization and median filtering to achieve a more even distribution of gray levels and to remove the noise within analyzed images, respectively. Pre-defined functions, such as medfilt2 for median filtering and histeq for the histogram equalization, from Matlab™ (Mathworks, Natick, Mass., USA) were used to perform the image pre-processing step. In order to quantify the dendrite area percentage, a threshold was used to create binary images from each SEM image to be used for analysis. Thresholding was performed following the automatic Otsu method within image processing software, ImageJ (National Institute of Health, Bethesda, Md., USA). Dendrites not defined by the automatic Otsu method were manually defined using the selection tool from ImageJ to cover the undefined dendrite areas left out of the threshold, which is illustrated in FIG. 2D. Finally, the area of the selected dendrites was calculated using a built-in automatic particle analysis tool within ImageJ as shown in previous works. This tool analyzes particles based on user defined constraints such as minimum and maximum size of the pixel area size and roundness or circularity of the shapes or particles. These constraints were used to identify the imaged particles defined by the pre-processing and threshold manipulation of the images to calculate the dendrite area over the metal matrix to estimate a TiN volume fraction.

Lastly, secondary arm spacing of the TiN dendrites was measured from the SEM images. ImageJ was used to measure the length of five primary dendrite arms in two SEM images. The number of secondary arms within the measured primary dendrite arm length were counted and divided by the total distance. The average dendrite arm spacing was calculated from a total of 20 measurements taken from two SEM images.

Table 1 presents a broad overview of the laser-assisted nitride processing parameters.

TABLE 1

| | | | | | Gaussian | Energy | Energy |
|---|---|---|---|---|---|---|---|
| | | | | Hatch | Beam | Flux | Flux |
| | P | V | | space | Diameter | Q | Q′ |
| | (w) | (mm/s) | Defocus | (mm) | (mm) | J/mm² | J/mm |
| Param 1 | 50 | 25 | 10 | 0.225 | 0.188 | 8.9 | 1.7 |
| Param 2 | | 15 | | | | 14.8 | 2.8 |
| Param 3 | | 35 | | | | 6.3 | 1.2 |
| Param 4 | | 25 | 16 | 0.350 | 0.284 | 5.7 | 1.6 |
| Param 5 | | | −10 | 0.225 | 0.188 | 8.9 | 1.7 |
| Param 6 | | | | 0.113 | | 17.8 | 3.3 |
| Param 7 | | | 16 | 0.175 | 0.284 | 11.4 | 3.2 |
| Param 8 | | | 10 | 0.169 | 0.188 | 11.9 | 2.2 |
| Param 9 | | 200 | 0 | 0.035 | 0.075 | 7.1 | 0.5 |
| Param 10 | 75 | 37.5 | 10 | 0.225 | 0.188 | 8.9 | 1.7 |
| Param 11 | | 75 | | | | 4.4 | 0.8 |
| Param 12 | | 150 | | | | 2.2 | 0.4 |
| Param 13 | 100 | 200 | | | | 2.2 | 0.4 |
| Param 14 | | 50 | | | | 8.9 | 1.7 |
| Param 15 | | 50 | −10 | | | 8.9 | 1.7 |
| Param 16 | 50 | 200 | 0 | 0.075 | 0.075 | 3.3 | 0.3 |

Table 2 shows corresponding TiN secondary dendrite arm spacings, volume fraction measurements, and Vickers microindentation hardness averages for the TiN coatings.

TABLE 2

| | | | | Secondary |
|---|---|---|---|---|
| | | | Volume | Arm |
| | Hardness | Thickness | Fraction | Spacing |
| | (GPa) | TiN (μm) | Dendrites | (μm) |
| Param 1 | — | 32 | 0.58 | 0.76 |
| Param 2 | — | 40 | 0.65 | 1.00 |
| Param 3 | — | 20 | 0.37 | 0.60 |
| Param 4 | 8.40 | 200 | 0.66 | 0.65 |
| Param 5 | 8.07 | 80 | 0.65 | 0.66 |
| Param 6 | 9.25 | 70 | 0.72 | 0.91 |
| Param 7 | 8.96 | 230 | 0.69 | 0.95 |
| Param 8 | — | 30 | 0.57 | 0.75 |
| Param 9 | 7.35 | 90 | 0.58 | 0.32 |
| Param 10 | 8.25 | 90 | 0.61 | 0.47 |
| Param 11 | — | 30 | 0.55 | 0.39 |
| Param 12 | — | 12 | 0.22 | 0.23 |
| Param 13 | — | 8 | 0.09 | 0.27 |
| Param 14 | 9.34 | 130 | 0.62 | 0.53 |
| Param 15 | 8.25 | 50 | 0.62 | 0.64 |
| Param 16 | — | 8 | 0.40 | 0.27 |

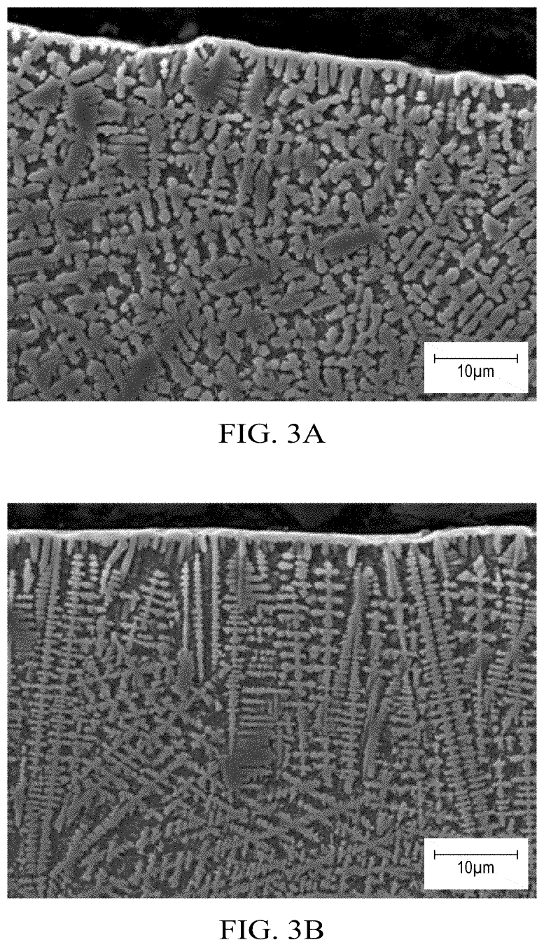

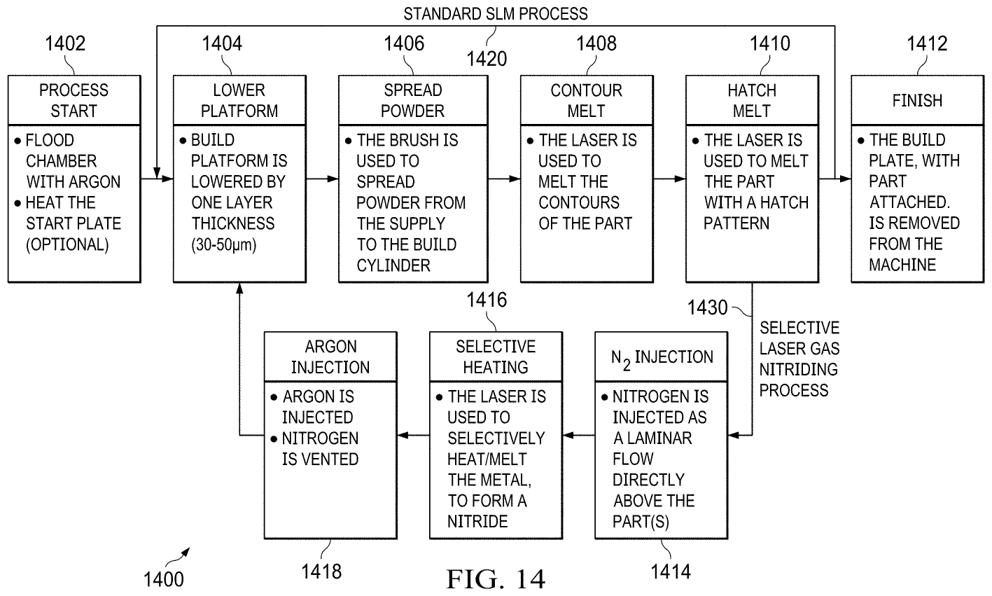

FIGS. 3A and 3B show two SEM secondary electron (SE) images for TiN surface coating microdendritic microstructures corresponding to processing parameters 7 (FIG. 3A) and 14 (FIG. 3B) in Tables 1 and 2. FIG. 3A shows coarse dendrites having secondary arm spacings of ˜0.95 μm, and a measured TiN volume fraction of 0.69. In contrast, FIG. 3B shows finer dendrites with a secondary arm spacing of 0.53 μm, and a measured TiN volume fraction of 0.62. It can be noted in FIGS. 3A and 3B that the primary dendrites grow from a fine, continuous TiN layer roughly 1 μm-thick. The growing microdendrites form crystallographic (oriented) regions or grains which vary from ˜10 to 40 μm mean diameter; with a propensity for orthogonal <100> dendritic (primary and secondary arm) regimes. Correspondingly, the propensity of primary dendrites growing from this continuous TiN surface layer are in the [001] orientation.

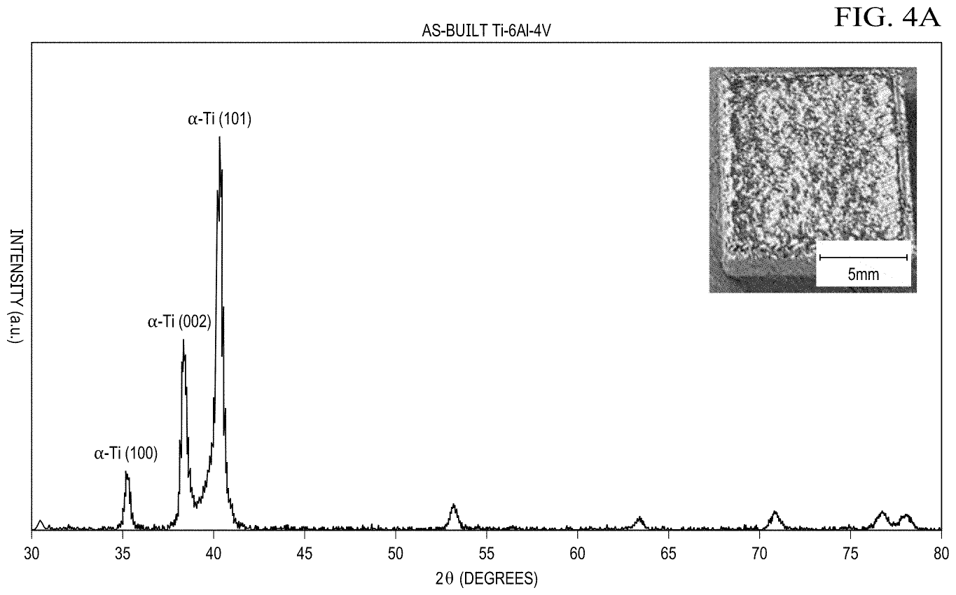

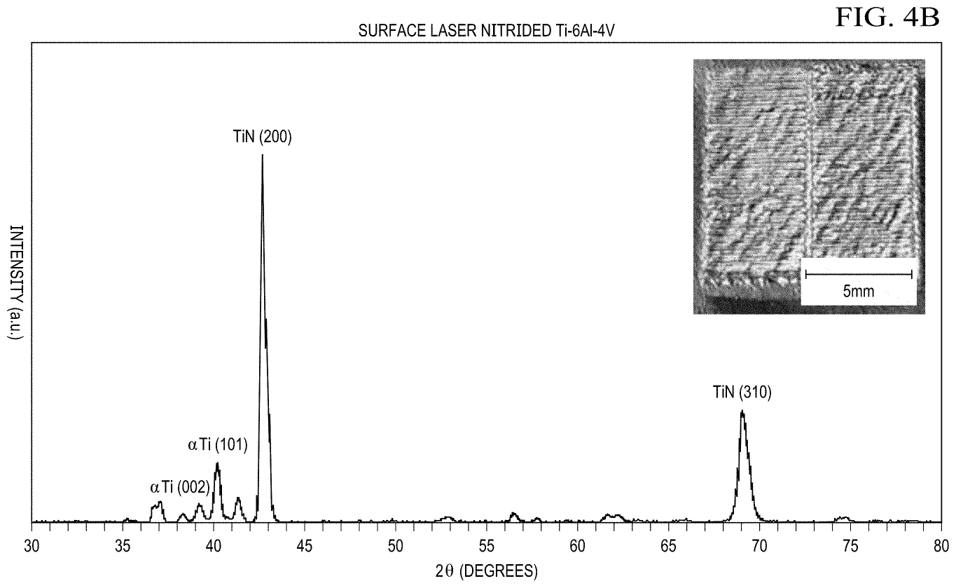

FIGS. 4A and 4B show for comparison the XRD spectra for the as-fabricated Ti-6Al-4V (hcp (S.G.: P6(3)/mmc; a=0.294 nm, c=0.468 nm) surface (FIG. 4A) and the laser-gas nitrided (TiN) surface (FIG. 4B). The XRD spectra in FIG. 4B corresponds to the 230 μm-thick TiN coating for process parameter 7 in Tables 1 and 2, and it confirms the TiN preferred (002) (or [001]) dendrite orientations in FIGS. 3A and 3B. The cubic (S.G.: Fm-3m) lattice parameter for the TiN peaks in FIG. 4B was measured to be ˜a=0.424 nm. This value often varies with the precise TiNₓ stoichiometry which correspondingly varies with the nitrogen concentration, pressure, temperature (and especially the thermal gradient, G), and solidification rate, S. Kloosterman and De Hosson have noted that TiN, having a normal melting point of ˜2930° C. in contrast to that for Ti-6Al-4V (1640° C.), is stable between 30 and 55 atomic percent nitrogen.

The thin (˜1 μm-thick) outer (and initial) TiN surface coating shown in FIGS. 3A and 3B forms initially by the exothermic reaction Ti+0.5 N₂--->TiN, or additionally by N₂-->2N+2Ti-->2TiN (or TiNₓ). TiN primary dendrites then continue to grow into the laser-beam melted Ti-6Al-4V surface region whose depth will depend primarily on the laser power (P) and scan speed, V; or the energy density Q (indicated as energy per unit area (J/mm²)- or linear energy density (J/mm) or Q′ in Table 1 and Equations (2) and (3), respectively. This dendritic growth is due primarily to constitutional supercooling but is also dependent upon the nitrogen concentration along with the diffusion through the initial, continuous TiN surface layer in FIGS. 3A and 3B, which is slower than through the Ti-6Al-4V alloy matrix. Labudovic, et al. have previously shown that the nitriding kinetics for gas-tungsten melting and re-solidification of Ti-6Al-4V surfaces obey parabolic laws controlling the nitrogen diffusion. Nitrogen concentration depth profiles calculated using Fick's second law of diffusion matched experimental nitrogen (or nitride) decay from the surface, and others have shown corresponding TiN dendritic microstructure depleting with increasing depth from the surface.

TiN dendrite microstructure formation (FIGS. 3A and 3B) is also influenced by the overall cooling rate, which although relatively rapid even for the laser melt-fabrication of the initial Ti-6Al-4V product in Ar, is even more rapid in pure N₂ during nitriding since the thermal conductivity of N₂ gas (0.026 W/mK) is roughly 44% higher than Ar gas (0.018 W/mK). Solidification processing by selective L-PBF melting, or scanning laser beam—N₂ gas surface processing, generally follows long-standing metal and alloy solidification fundamentals, where cooling rate, R, is equal to the product of solidification rate, S, and thermal gradient, G:

R=SG. (4)

For many traditional solidification regimes forming dendrite microstructures, the secondary dendrite arm spacing decreases with increasing cooling rates according to the Kurz-Fisher relationship:

(d₂)=A/R^{1/3} (5)

where A is a constant. It is also well established that the cooling rate is related to the laser power or energy density, Q, through a relationship of the form:

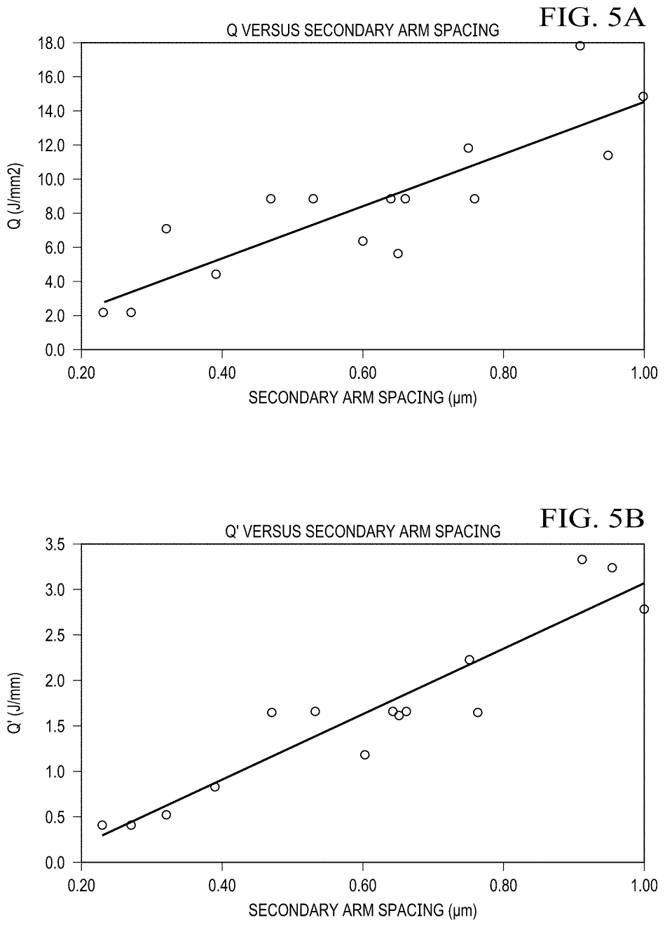

R=A′/e^{aQ} (6)

where A′ and a are constants. Equation (6) represents an exponential decay curve when plotting R versus Q, where the cooling rate, R, decreases exponentially with increasing Q. Correspondingly, as noted above (Equations (5) and (6)), plots of energy density (Q) versus secondary dendrite arm spacing generally result in a linear relationship. This linear relationship is illustrated in FIGS. 5A and 5B which correspond to energy/unit area (Q) and linear energy density (Q′) (Tables 1 and 2, and Equations (2) and (3)), respectively.

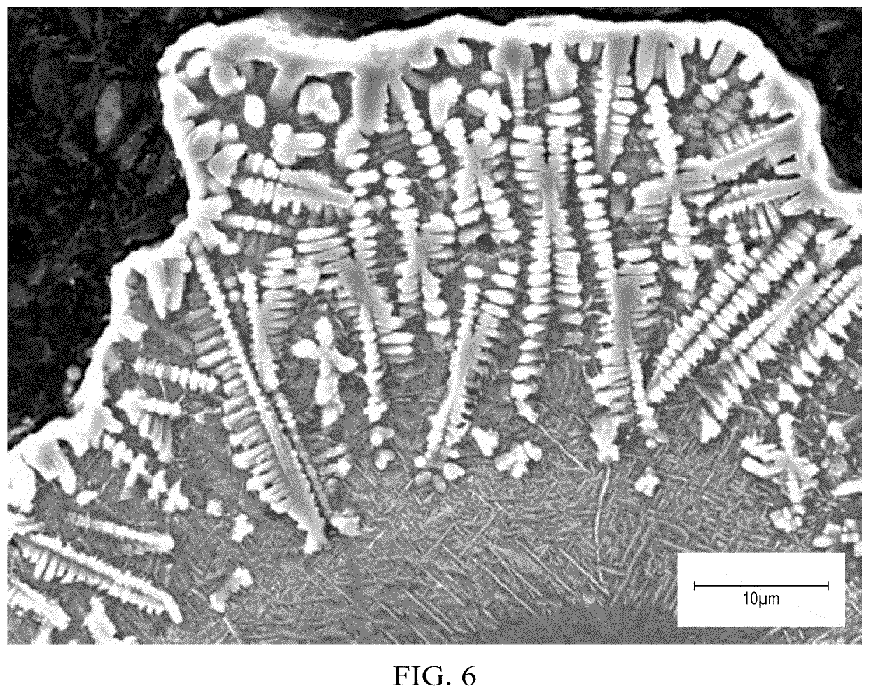

For L-PBF processed Ti-6Al-4V alloy, the rapid cooling rates also promote the formation of thin, martensite (α′) platelets which become finer and more prolific as the cooling rate increases. This martensitic transformation is also manifested in the nitriding of the Ti-6Al-4V AM components (see FIGS. 3A and 3B), where α′ platelets or needles are intermixed with the TiN microdendritic microstructure, and result in an α′ phase-rich region just below the TiN (dendritic) regime in the nitride coating layer. This feature is prominently illustrated in the SEM view of a nitride-layer segment shown in FIG. 6.

Generally, increasing cooling rates refine or decrease microstructure geometries (refining features or decreasing the feature thickness and spacing). For example, in electron beam powder bed fusion fabrication of Ti-6Al-4V, the α-phase lenticular grain dimensions are refined with increasing cooling rates while in L-PBF not only is the lenticular α-grain structure (thickness) reduced, but increasing volume fractions of fine, α′ martensite platelets are introduced with increased cooling rates, often dominating the microstructure as shown in FIG. 6. This effect results in microindentation (Vickers) hardness increases from ˜3 GPa for the larger a phase lenticular grain structures to more than 4.5 GPa for high volume fractions of α′ martensite structures shown in FIG. 6. This increasing hardness is, in fact, the general rule for strengthening or hardening by microstructures in metal and alloys: smaller features or feature sizes produce higher strength and hardness. Indeed, in a recent study involving the development of dendritic microstructures in 316L stainless steel by direct laser deposition (DLD), Amine, et al. showed that hardness decreased with increasing secondary dendrite arm spacing (a negative linear slope). Amine, et al. also showed a linear, positive slope for the secondary dendrite arm spacing versus laser power; similar to the results shown in FIGS. 5A and 5B.

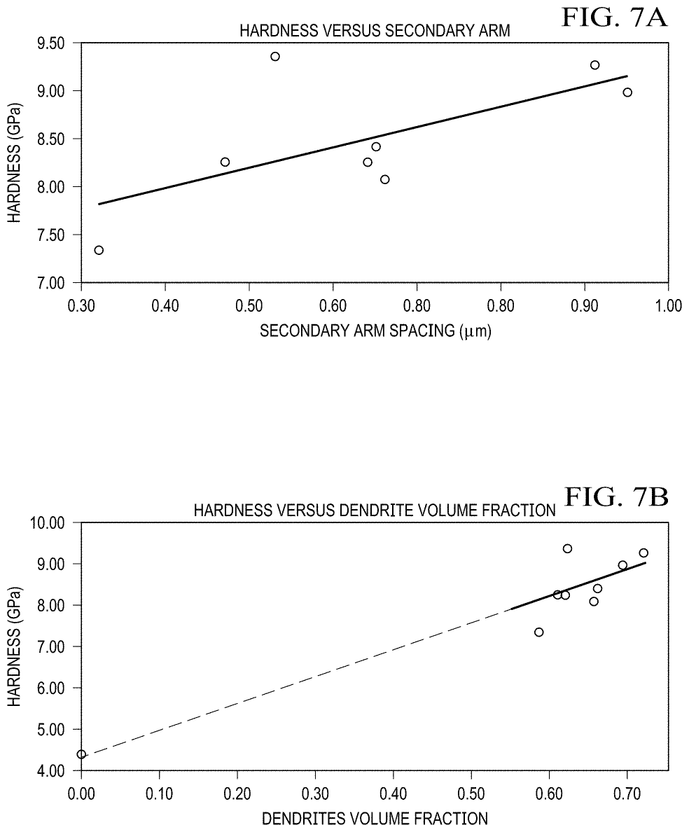

As shown in FIG. 7A, for the in-situ laser gas nitriding of the Ti-6Al-4V surfaces (see FIGS. 3A and 3B), the Vickers microindentation hardness for the TiN layers actually decreases with decreasing secondary arm spacing. This apparent paradox occurs because as the secondary dendrite arm spacing is reduced, the TiN volume fraction decreases as well (compare FIGS. 3A and 3B).

Correspondingly, the Vickers microindentation hardness increases with increasing TiN dendrite volume fraction as shown in FIG. 7B. The basis for this paradox is vested in the fact that for more traditional strengthening microstructures, even the microdendritic microstructures for 316L stainless steel noted above, there is no significant or apparent variation in the elastic (or Young's) modulus. However, in the case of TiN, the Young's modulus is far greater than the Ti-6Al-4V α-phase matrix (or base), which is ˜110 GPa. For example, the Young's modulus for 97% dense TiN ceramic has been measured to be ˜460 GPa, corresponding to a Vickers microindentation hardness of ˜20 GPa. More recent comparisons of Vickers microindentation hardness and Young's modulus for TiN coatings on Ti-6Al-4V prepared by a so-called powder immersion reaction-assisted coating (PIRAC) technique, showed hardness values of ˜11 GPa corresponding to Young's moduli ranging from 234 GPa to 293 GPa, in contrast to physical vapor deposited (PVD) TiN coatings on Ti-6Al-4V having hardness values of ˜22 GPa and corresponding to a Young's modulus of ˜426 GPa. Extrapolation of the hardness versus TiN dendrite volume fraction in FIG. 7B to a volume fraction of 1 results in a Vicker microindentation hardness of ˜11 GPa. Results similar to FIG. 7B have also been reported by Mridha for TiN coating formation by TIG surface melting of titanium.

In a recent paper by Feng, et al., it was demonstrated that the Young's modulus for the martensitic α′ phase in Ti-6Al-4V had a value of 146 GPa in contrast to the nominal 110 GPa Young's modulus for the α-phase Ti-6Al-4V. Consequently, the α′ phase region hardness may be influenced by the fine needle (platelet) structure, but also by the 33% increase in the Young's modulus for the α′ martensite in contrast to the α-phase.

Tables 1 and 2, along with the representative TiN surface coating microstructures in FIGS. 3A and 3B, and graphical representations shown in FIGS. 5A-5B and 7A-7B, demonstrate the ability to selectively harden surface regions on Ti-6Al-4V products processed by L-PBF in Ar and replacing the Ar with N₂ gas and laser beam re-melting of selective surface regions to form TiN coatings. Since such L-PBF fabricated Ti-6Al-4V products can have variously complex geometries, this selective surface nitriding can lead to novel and otherwise unattainable applications. These applications include wear and corrosion resistant coatings in various aerospace and automotive industries, biomedical applied coatings, specially hardened cutting tools and machine parts, and others.

In addition to the ability to produce selectively nitrided surface regions in the AM processing of Ti-6Al-4V products, it is also possible to create embedded TiN layers in L-PBF-fabricated Ti-6Al-4V components by building on top of nitride layers to produce periodic, planar Ti-6Al-4V/TiN/Ti-6Al-4V structures having various thicknesses and hardness: ductile/hard (or stiff)/ductile periodicities. This concept will allow the design of selective, novel, multilayer, alloy/ceramic, planar composite structures. Such hybrid, composite configurations composed of stiff or high Young's modulus and high damping TiN layers in a ductile, lower modulus Ti-6Al-4V periodically varying matrix can exhibit exceptional toughness as a consequence of the deflection and arrest of crack propagation by the stiff (TiN) layers. These features, especially toughness, are readily apparent in the periodic (alternating) hard ceramic/soft polymer-like layering of natural biological systems such as mollusk shells and pearls, where thick (400-500 nm) layers of hard aragonite (CaCO₃) are separated by ˜10 nm thick layers of soft, organic chitin (or conchiolin).

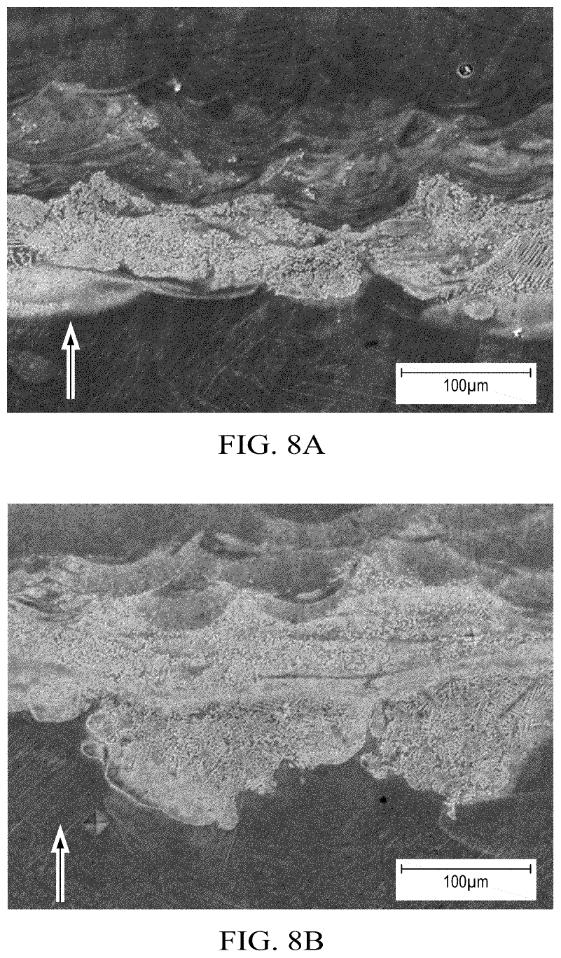

FIGS. 8A and 8B illustrate two examples of embedded TiN layers in the L-PBF fabricated Ti-6Al-4V using alternating Ar—N₂—Ar build gas environments in this study. Arrows within the figures indicate the build direction of the L-PBF process. While these TiN microdendritic layers exhibit irregular melt-pool structures, their functionality as stiff layers in the more ductile Ti-6Al-4V is preserved.

The nitriding parameters used to create the embedded layer shown in FIGS. 8A and 8B are identical to those shown in Table 3 below, even though the nominal nitride thickness is drastically different between the two

TABLE 3

| | | | Spot | Hatch | # layers |
|---|---|---|---|---|---|
| | P | V | Diameter | space | reduced |
| | (w) | (mm/s) | (mm) | (mm) | power |
| Nitriding Parameter 7 | 50 | 25 | 0.284 | 0.175 | n/a |
| Unaltered infill | 300 | 1000 | 0.08 | 0.090 | n/a |
| Reduced power infill | 165 | 1000 | 0.08 | 0.090 | 2 |

This variation is a result of the following iterations of melting Ti-6Al-4V layers on top of the nitride layer with altered melt parameters. While the nitriding parameters offer extensive control over the TiN formation, this step is only part of the process and full control over all layers is required.

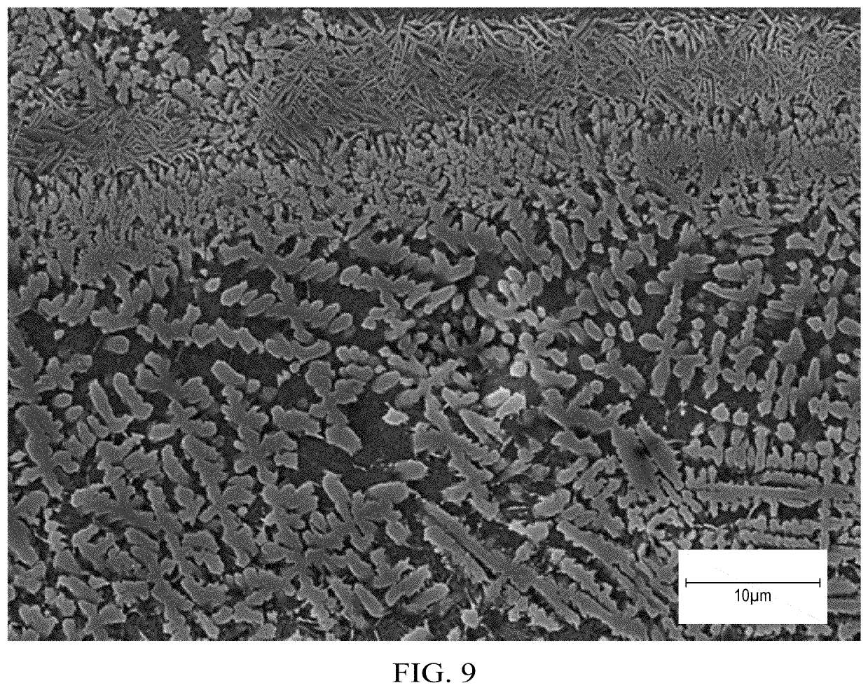

FIG. 9 shows a magnified TiN layer section of FIG. 8B, which exhibits a complex intermixing of microdendritic TiN microstructures and volume fractions along with α′ phase martensitic platelets at the interface of the TiN layer and the continuous Ti-6Al-4V build overgrowth. Also visible in FIG. 9 is a micro indentation from the hardness profile, the hardness value at this location is 8.85 GPa and the variability in the composite structure expressing the wide range of hardness values recoded across all samples. The complex intermixed TiN/Ti-6Al-4V structure would yield differing measurement results strictly based on the indent location, even movements as small as 10 μm could drastically alter the hardness measurement.

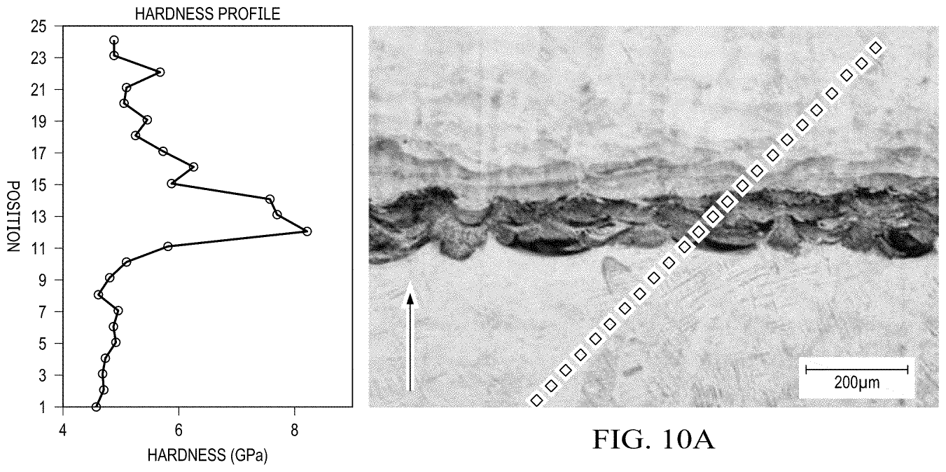

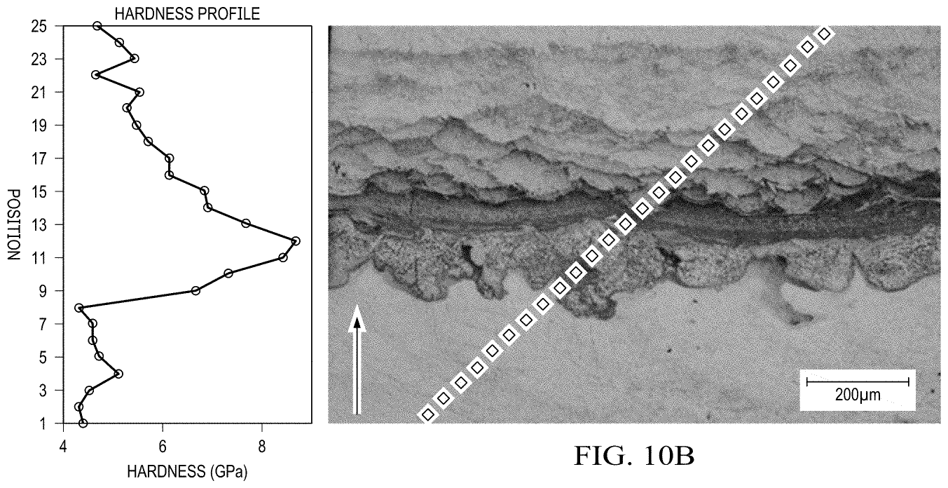

FIGS. 10A and 10B show two embedded TiN layer examples (in Ti-6Al-4V) with linear Vickers microindentation hardness profiles which exhibit the soft (ductile) Ti-6Al-4V/stiff TiN-ductile Ti-6Al-4V planar composite features. The hardness profile clearly shows a graded interface with a sharp transition from the Ti-6Al-4V to the TiN layer along the build direction (shown as an arrow in FIGS. 10A and 10B). The subsequent deposition of the Ti-6Al-4V onto the TiN layer showed a gradient transition in hardness caused by the continuous intermixing of new Ti-6Al-4V and the previously solidified TiN/Ti-6Al-4V composite layer. The associated α′ martensite phase is also apparent in the Ti-6Al-4V matrix shown below the TiN layer in FIG. 10B. These prototype, hybrid, layered, composite examples provide compelling evidence for the prospects of creating novel, complex multilayer, structural and functional composites by laser gas nitriding using L-PBF AM.

The research results reported in this paper have demonstrated that novel, laser-assisted gas nitriding of L-PBF processed Ti-6Al-4V can be achieved in-situ by alternating the Ar build gas with N₂. Systematic variation of processing parameters can also achieve TiN surface coatings ranging from several tens of microns to several hundred microns; having variations in TiN dendritic microstructure volume fractions ranging from 0.6 to 0.75, with corresponding Vickers microindentation hardness values ranging from ˜7.5 GPa to 9.5 GPa. The resulting TiN dendritic volume fractions represent Young's moduli variations estimated to range from ˜150 GPa to 200 GPa.

TiN layers ranging in thickness from 50 μm to 150 μm and embedded in the L-PBF fabricated Ti-6Al-4V matrices were also achieved by in situ laser-assisted gas nitriding, providing convincing prototype structures as prospects for creating hybrid, periodic, planar composites having alternating stiff and ductile regimes that can be selectively tailored, and exhibiting the characteristic toughness of biological systems such as mollusk shells.

Further, it is possible to use the techniques described in this article to fabricate complex TiN/Ti-6Al-4V metal matrix composites, with complex three-dimensional TiN reinforcement, by forming discontinuous TiN layers and stacking the subsequent TiN layers, similar to the standard L-PBF process with gas exchange on specific layers. Demonstrations of these specific capabilities are the subject of ongoing work. The results of this study produced TiN layers having a Vickers microindentation hardness ranging from ˜8.5 GPa to 9.5 GPa embedded in Ti-6Al-4V matrices having hardness values ranging from ˜4.5 GPa to 5 GPa.

These results demonstrate the ability to systematically produce selective TiN surface coatings and embedded layers representing novel, planar composite designs in ductile Ti-6Al-4V fabricated by L-PBF AM by alternating Ar and N₂ gas build environments. Furthermore, this work demonstrates the potential of AM, in addition to the geometric design freedom, to provide a new paradigm of materials and engineering design for the fabrication of materials with tailored compositions and mechanical properties.

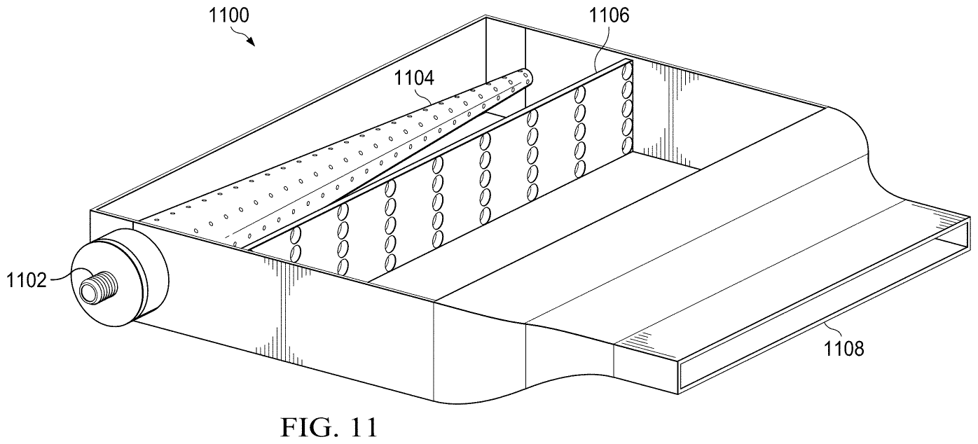

FIG. 11 depicts a cross-section perspective view of a gas sprayer in accordance with an illustrative embodiment. Gas sprayer 1100 comprises gas inlet 1102, which feeds into diffuser 1104. Gas from diffuser 1104 then passes through flow straightener 1106 before exiting sprayer 1100 through contraction nozzle 1108.

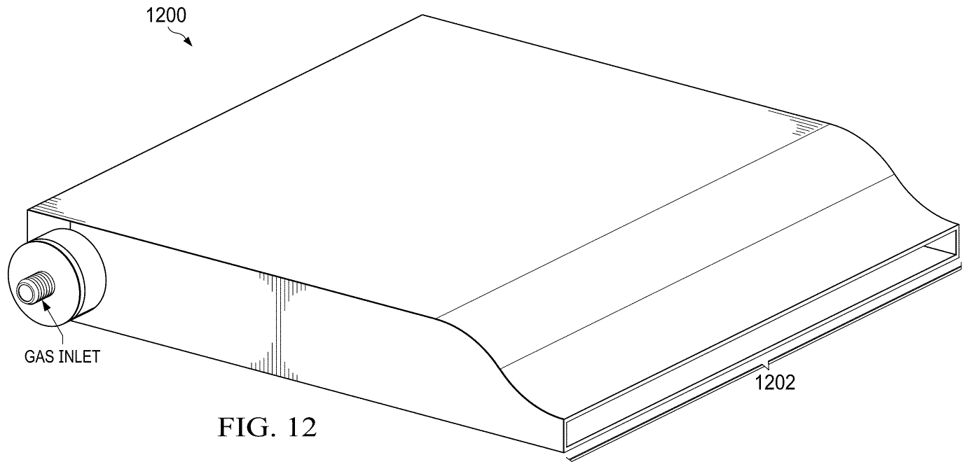

FIG. 12 depicts a perspective view of a gas sprayer in accordance with an illustrative embodiment. Gas sprayer 1200 is an alternate embodiment which has a slightly different taper to gas outlet 1202 than that of sprayer 1100.

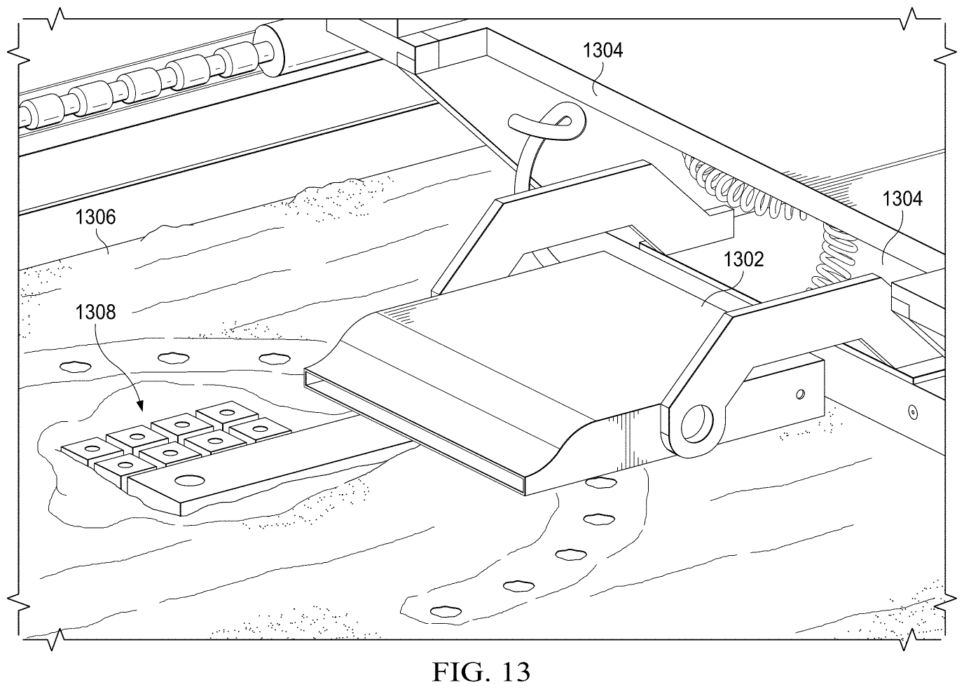

FIG. 13 depicts a gas sprayer in use during fabrication of parts in accordance with an illustrative embodiment. Nitrogen sprayer 1302 is connected to rake 1304, which passes over powder bed 1306 in which parts 1308 are being fabricated.

FIG. 14 depicts a flowchart illustrating a process flow for powder bed fusion manufacturing with nitriding in accordance with an illustrative embodiment. Process 400 adds a selective laser gas nitriding process 1430 to a standard selective laser melting (SLM) process 1420.

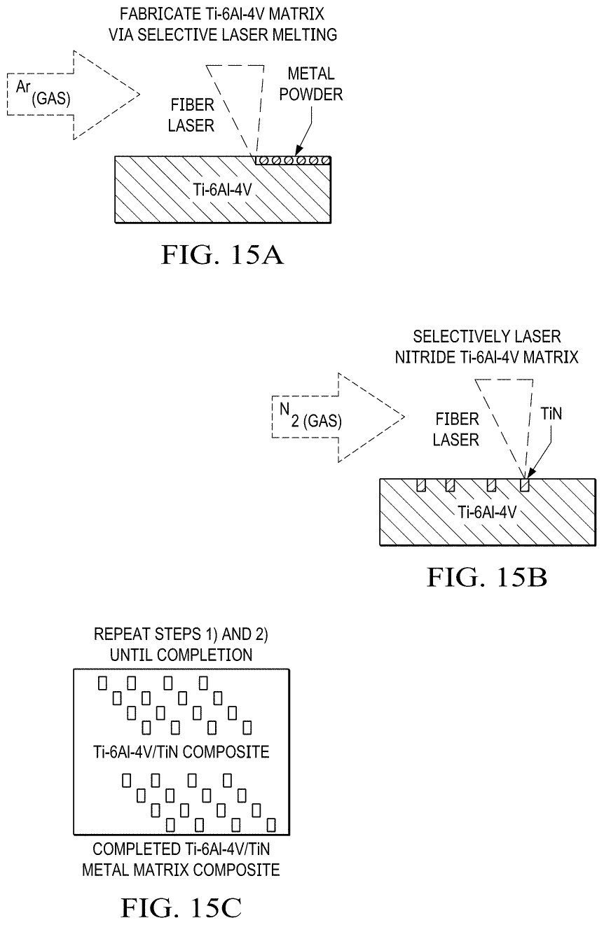

Process 400 begins by flooding the L-PBF chamber with Argon and optionally heating the start plate (step 1402). Next the standard SLM process 1420 is illustrated in the diagram in FIG. 15A and begins by lowering the build platform by one layer thickness (30-50 μm) (step 1404). The brush is used to spread powder from the supply to the build cylinder (step 1406). The laser is used to melt the contours of the part (step 1408). The laser is then used to melt the part with a hatch pattern (step 1410).

After step 1410, selective laser gas nitriding process 1430 begins, illustrated in the diagram in FIG. 15B. Nitrogen is injected as a laminar flow directly above the part(s) being manufactured (step 1414). The laser is then used to selectively heat/melt the metal to form a nitride (step 1416). If standard SL process 1420 is to be repeated, argon is injected back into the chamber, and the nitrogen is vented (step 1418).

Standard SLM process 1420 and selective laser gas nitriding process 1430 are alternately repeated until the final metal matrix composited is completed, as shown in FIG. 15C.

As used herein, the term “particulate material” generally refers to matter in particulate form. As used herein, the term “particulate,” or contextual variants thereof, generally means being relating to or being in the form of separate particles. As used herein, the term “particle,” or contextual variants thereof, generally refers to a portion or fragment of matter. In some illustrative examples, particles can range in size from 5 μm to 300 μm, and can have any type of shape—for example, at least one of spherical, oblate, prolate, spheroid, cylindrical, orthorhombic, regular, irregular, or the like. Additionally, a quantity of particles comprising a same material can be provided in any number of sizes, or any number of shapes.

The term “powder” generally refers to material comprising particles that have a shape and size that can flow freely when shaken or tilted. A powder can also have a tendency to clump. As such, a powder can be understood to correspond to a type of particle; however, it will be appreciated that not all particles comprise powders. In some illustrative examples, powders can range in size from 5μ to 300μ, and can have any type of shape—for example, at least one of spherical, oblate, prolate, spheroid, cylindrical, orthorhombic, regular, irregular, or the like. Additionally, a quantity of powder comprising a same material can be provided in any number of particle sizes, or any number of particle shapes.

Formation of a first feature “over” or “on” a second feature may include examples in which the first and second features are formed in direct contact, and may also include examples in which additional features may be formed between the first and second features, such that the first and second features may not be in direct contact. Spatially relative terms, such as “up,” “down,” “under,” “beneath,” “below,” “lower,” “upper,” “above,” “over,” “higher,” “adjacent,” “interadjacent,” “interposed,” “between,” or the like, may be used herein for ease of description to representatively describe one or more elements or features in relation to other elements or features as representatively illustrated in the Figures. Spatially relative terms are intended to encompass different orientations of devices or objects in use or operation, in addition to orientations illustrated in the Figures. An apparatus, device, or object may be otherwise spatially transformed—for example, rotated by 90 degrees—and the spatially relative descriptors used herein may likewise be interpreted accordingly.

Flowcharts and block diagrams in different depicted examples illustrate architecture, functionality, and operation of some possible implementations of apparatuses and methods in illustrative examples. In this regard, each block in flowcharts or block diagrams can represent at least one of a module, a segment, a function, or a portion of an operation or step. The Figure illustrations are not meant to imply physical or architectural limitations to the manner in which illustrative examples may be implemented. Other components in addition to or in place of ones illustrated may be used. Some components may be unnecessary. Additionally, blocks are presented to illustrate some functional components. One or more blocks may be combined, divided, or combined and divided into different blocks when implemented in an illustrative example. In some examples, to the extent multiple steps are shown as sequential in the specification, figures, or claims, some combination of such operations in other examples may be performed at a same time or in a different order. The sequence of operations described herein may be interrupted, suspended, or otherwise controlled by another process.

As used herein, the phrase “a number” means one or more. The phrase “at least one of”, when used with a list of items, means different combinations of one or more of the listed items can be used, and only one of each item in the list may be needed. In other words, “at least one of” means any combination of items or number of items can be used from the list, but not all of the items in the list are required. The item can be a particular object, a thing, or a category. For example, without limitation, “at least one of item A, item B, or item C” may include item A, item A and item B, or item B. This example also may include item A and item B and item C, or item B and item C. Of course, any permutative combination of these items can be present. In some illustrative examples, “at least one of” can be, for example, without limitation: two of item A, one of item B, and ten of item C; four of item B and seven of item C; or other suitable combinations.

As used herein, the terms “comprises,” “comprising,” “includes,” “including,” “has,” “having,” or any contextual variant thereof, are intended to cover a non-exclusive inclusion. For example, a process, product, composition, article, or apparatus that comprises a list of elements is not necessarily limited to only those elements, but may include other elements not expressly listed or inherent to such process, product, composition, article, or apparatus.

Furthermore, unless expressly stated to the contrary, “or” refers to an inclusive or and not an exclusive or. That is, the term “or” as used herein is generally intended to mean “and/or” unless otherwise indicated. For example, a condition A or B is satisfied by any one of the following: A is true (or present) and B is false (or not present), A is false (or not present) and B is true (or present), and both A and B are true (or present). As used herein, a term preceded by “a” or “an” (and “the” when antecedent basis is “a” or “an”) includes both singular and plural of such term, unless the context clearly indicates otherwise. Also, as used in the description herein, the meaning of “in” includes “in” and “on,” unless the context clearly indicates otherwise.

Use of the term “example,” or contextual variants thereof, in no way indicates admission of prior art. Furthermore, particular features, structures, properties, or characteristics of any specific example may be combined in any suitable manner with one or more other examples. In illustrative examples, uniform hatching, or absence of hatching, illustrated in the Figures may correspond to a substantially homogenous material. In other illustrative examples, unitary hatching, or absence of hatching, may represent one or more component material layers.

The description of the different illustrative embodiments has been presented for purposes of illustration and description, and is not intended to be exhaustive or limited to the embodiments in the form disclosed. Many modifications and variations will be apparent to those of ordinary skill in the art. Further, different illustrative embodiments may provide different features as compared to other illustrative embodiments. The embodiment or embodiments selected are chosen and described in order to best explain the principles of the embodiments, the practical application, and to enable others of ordinary skill in the art to understand the disclosure for various embodiments with various modifications as are suited to the particular use contemplated.

What is claimed is:

1. A method of additive manufacturing, the method comprising:
forming a three-dimensional part by:
injecting a first gas into a build chamber;
depositing a first layer of metal-containing powder over a build platform;
melting the first layer of metal-containing powder with a first laser device;
cooling the first layer of metal-containing powder; and
after the cooling, optionally repeating the depositing, the melting, and the cooling to build additional layers of the three-dimensional part;
forming a coating on a surface of the three-dimensional part by:
injecting a second gas into the build chamber, wherein the second gas is introduced over the surface of the three-dimensional part, the second gas different than the first gas;
selectively heating a portion of the surface of the three-dimensional part with a second laser device, wherein the portion of the surface of the three-dimensional part is chemically altered to form the coating; and
after forming the coating, injecting an additional aliquot of the first gas into the build chamber while venting the second gas from the build chamber.

2. The method of claim 1, wherein the surface of the three-dimensional part is interposed between a first layer of the three-dimensional part and a second layer of the three-dimensional part.

3. The method of claim 1, wherein the surface of the three-dimensional part is an exterior surface of the three-dimensional part.

4. The method of claim 1, wherein the second laser device is the first laser device.

5. The method of claim 1, wherein the first gas is an inert gas and the second gas is a chemically reactive gas.

6. The method of claim 5, wherein:
the metal-containing powder comprises titanium (Ti);
the inert gas is Argon (Ar);
the chemically reactive gas is at least one of molecular nitrogen (N₂) or ammonia (NH₃); and
the coating comprises titanium nitride (TiN).

7. The method of claim 6, wherein the metal-containing powder comprises Ti-6Al-4V.

8. The method of claim 1, further comprising:
prior to injecting the second gas into the build chamber, forming a hatch pattern on the surface of the three-dimensional part.

9. The method of claim 1, wherein injecting the second gas into the build chamber comprises introducing the second gas in a laminar flow disposed over the surface of the three-dimensional part.

10. The method of claim 1, wherein the second gas is introduced directly over the surface of the three-dimensional part.

11. The method of claim 1, wherein selective heating of the portion of the surface of the three-dimensional part comprises second melting a portion of the three-dimensional part disposed on the portion of the surface of the three-dimensional part.

12. The method of claim 1, wherein the second gas is injected into the build chamber with a flow assembly disposed over the surface of the three-dimensional part.

13. The method of claim 12, wherein the flow assembly comprises:
an inlet;
a diffuser;
a flow straightener; and
a nozzle outlet.

14. The method of claim 13, wherein the nozzle outlet comprises a laminar flow nozzle.

15. The method of claim 14, wherein the flow straightener is interposed between the diffuser and the laminar flow nozzle.

16. The method of claim 15, wherein the diffuser is interposed between the inlet and the flow straightener.

17. The method of claim 16, wherein:
a first cross-section of gas flow exiting the nozzle outlet has a first cross-sectional area;
a second cross-section of gas flow interposed between the flow straightener and the nozzle outlet has a second cross-sectional area; and
the first cross-sectional area is less than the second cross-sectional area.

18. The method of claim 13, wherein the flow assembly is mounted on a rake of a laser powder bed additive manufacturing system.

19. The method of claim 1, wherein cooling comprises an actively removing thermal energy from the first layer of metal-containing powder.

20. The method of claim 1, wherein cooling comprises passively allowing the first layer of metal-containing powder to radiatively dissipate heat to the local environment.

21. A three-dimensional part comprising:
a Ti-6Al-4V/TiN metal matrix composite.

22. The three-dimensional part of claim 21, wherein the Ti-6Al-4V/TiN metal matrix composite comprises alternating layers of Ti-6Al-4V and TiN.

23. The three-dimensional part of claim 22, wherein the Ti-6Al-4V/TiN metal matrix composite comprises a periodic, planar structure of varying layer thicknesses.

24. The three-dimensional part of claim 21, wherein the varying layer thicknesses correspond to alternating stiff and ductile layers.

25. The three-dimensional part of claim 22, wherein stiff layers comprise TiN, and ductile layers comprise Ti-6Al-4V.
